(19) United States
(12) Patent Application Publication
(10) Pub. No.: US 2017/0232587 A1
(43) Pub. Date: Aug. 17, 2017

(54) SINK FAUCET MULTIPLE TOOL

(71) Applicant: Gaspare Joseph Tommaso, Brooklyn, NY (US)

(72) Inventor: Gaspare Joseph Tommaso, Brooklyn, NY (US)

(21) Appl. No.: 15/043,541

(22) Filed: Feb. 13, 2016

(51) Int. Cl. B25B 13/50; B25B 13/06

(52) U.S. Cl. CPC B25B 13/5091; B25B 13/065; E03C 1/0403

(57) ABSTRACT

The “Sink Faucet Multiple Tool”, is designed so that on one side it can install or remove two types of faucet nuts that fix the faucet to the underside of the sink or lavatory, and on the other side it can install or remove the faucet nut that connects the flexible water hoses to the faucet. It is designed to be easy to use and inexpensive.

### CROSS REFERENCING OF RELATED APPLICATIONS

U.S. Patent Documents

| | | | |
|---|---|---|---|
| 5,048,378 | Sep. 17, 1991 | Nikolas | 81/124.2 |
| 7,114,418 | Aug. 3, 2006 | Allen | 81/177.2 |
| 4,682,399 | Jul. 28, 1987 | Heimbach | 29/426.4 |

### BACKGROUND OF THE INVENTION

The tool described in U.S. Pat. No. 5,048,378 can only remove or install a faucet nut with four projecting wins. My invention can install or remove a faucet nut with either four or three projecting wings, and it can also be used to remove or install the larger faucet nut of the flexible tube that connects the faucet to the water supply.

The tool described in U.S. Pat. No. 7,114,418 is a tool that is used to install or remove a faucet seat. Similarly to my invention, it uses a socket. Unlike my invention, it cannot be used to install or remove a faucet.

The tool described in U.S. Pat. No. 4,682,399 achieves the removal of a faucet by using a tube with cutting teeth that cuts through the nut that secures the faucet to the sink. When removing the nut one can damage the underside of the sink, and will produce a lot of debris. My invention does not produce any debris, and has multiple uses.

Presently, a faucet is installed on a kitchen sink by first reaching behind the sink, usually by crawling as far as possible into the kitchen cabinet, so as to reach the faucet nipple. This is necessary so as to screw the faucet nut and tighten it by hand, and then with a plier or wrench. Holding a plier or wrench in the confined space behind the sink is a difficult job. The nipple of the faucet is then connected similarly to the water hose. This operation has to be repeated two times, because a faucet has a cold and hot water nipple connection.

This manual installation described above is uncomfortable and cramped. It can also be very time consuming, due to the very limited accessibility behind the sink.

The removal of a kitchen sink faucet consists of the installation steps in is reverse, with the additional difficulty of having to loosen the faucet nuts that have set themselves in place.

The installation or removal of bathroom faucets is similar to that of kitchen faucets, depending on the type of cabinet or pedestal.

### SUMMARY OF THE INVENTION

The Sink Faucet Multiple Tool makes the installation of faucets very inexpensive, and easy enough for just about anyone to do it. This is because the tool consists of a two inch diameter PVC pipe which is from about four to twelve inches long. The preferred length is about twelve inches long. At one end of this pipe is a six sided socket designed to receive the larger six sided nut that attaches the flexible water hose to the nipple of the faucet.

At the other end of this PVC pipe are six notches, that are about a quarter of an inch deep. Four of the notches are set 90 degrees apart. The additional 2 notches are set 120 degree apart from one of the original four notches. These notches are on the rim of one end of the pipe. These notches can fit the four or thee projecting wings of a four ridged (winged) or three ridged (winged) faucet nut. Once the ridges or wings of the faucet nut are engaged by the notches of the tool, the pipe can be manually turned to screw or unscrew the faucet nut. One advantage of this tool is that the PVC pipe has a two inch diameter, and can be easily held and turned by hand. The other advantage is that the PVC pipe can easily reach the faucet nut behind the sink.

### DESCRIPTION OF THE DRAWINGS

FIG. 1 is a view of the Sink Faucet Multiple Tool showing the PVC tube or pipe with the six notches at the end. Number 1 refers to the two inch diameter PVC tube or pipe. Number 2 refers to the end of the tube that contains the notches. Number 3 refers to the notches that engage the faucet retaining nuts. Number 4 refers to the other end of the PVC tube.

FIG. 2 is a frontal view of the notched end of the Sink Faucet Multiple Tool. The parts identified in the drawing are: Number 2 refers to the end of the tube that contains the notches. Number 3 refers to the notches that engage the faucet retaining nuts.

FIG. 3 is a view of the Sink Faucet Multiple Tool showing the end that has the six sided hole that is designed like a socket to receive the larger six sided nut that attaches the flexible water hose to the nipple of the faucet. Numbers 1 through 4 are the same references as in FIG. 1. Number 5 refers to the six sided hole that is designed like a socket.

FIG. 4 is a frontal view of the Sink Faucet Multiple Tool showing the end that has the six sided hole that is designed like a socket to receive the larger six sided nut that attaches the flexible water hose to the nipple of the faucet. Numbers 4 and 5 are the same as in FIG. 3.

FIG. 5 is a view of the faucet nut with three projecting wings that are engaged by the notched side of the Sink Faucet Multiple Tool. Number 6 refers to the faucet retaining nut. Number 7 refers to the threaded center hole of the nut. Number 8 refers to the projecting wing of the nut.

FIG. 6 is a view of the faucet nut with four projecting wings that are engaged by the notched side of the Sink Faucet Multiple Tool. Number 6 refers to the faucet retaining nut. Number 7 refers to the threaded center hole of the nut. Number 8 refers to the projecting wing of the nut.

FIG. 7 is a view of the flexible hose that is used to connect the faucet to the water supply. Number 9 refers to the flexible water hose. Number 10 refers to larger sided nut of the flexible hose.

FIG. 8 is a view of the Sink Faucet Multiple Tool 1, engaging the larger nut 10, of the flexible faucet hose 9, that is installed onto the faucet nipple 11. The smaller nut 12, at the end of the flexible hose 9 can also be seen.

FIG. 9 is a view of the Sink Faucet Multiple Tool 1, engaging the faucet nut 6 that is installed onto the nipple of the faucet. The notches of the faucet tool 3 encompass the projecting wings 8 of the faucet nut 6,

### DETAILED DESCRIPTION OF THE INVENTION

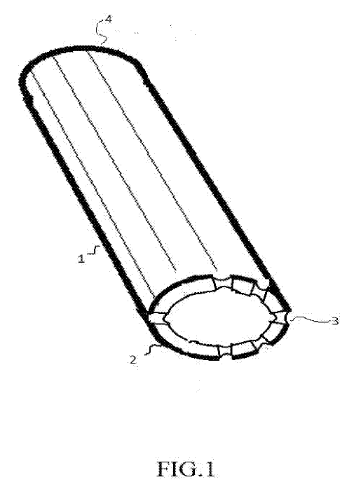

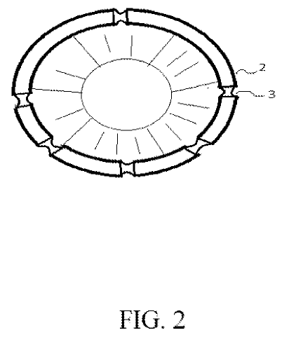

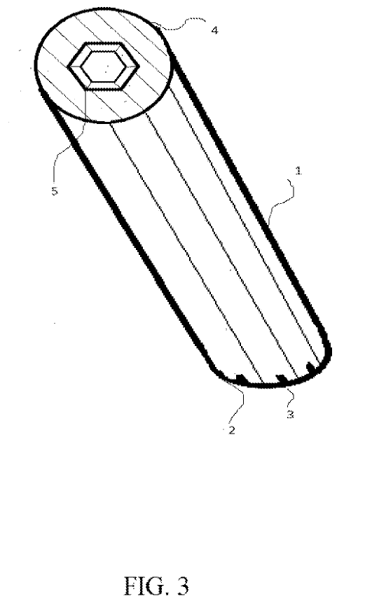

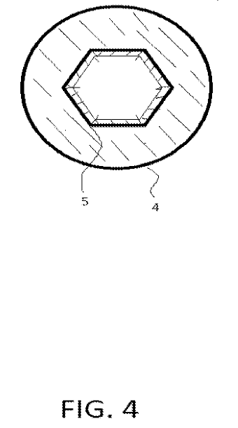

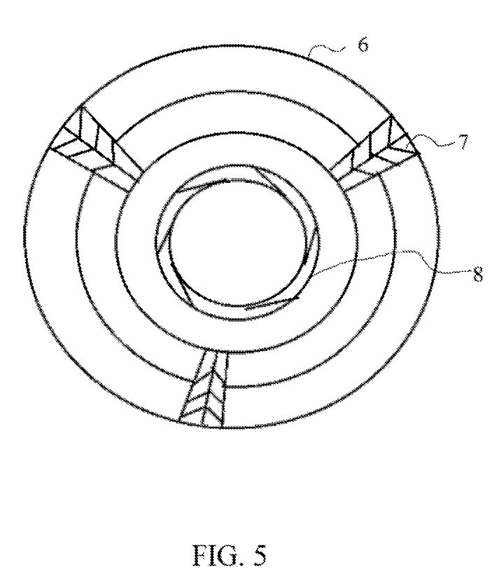

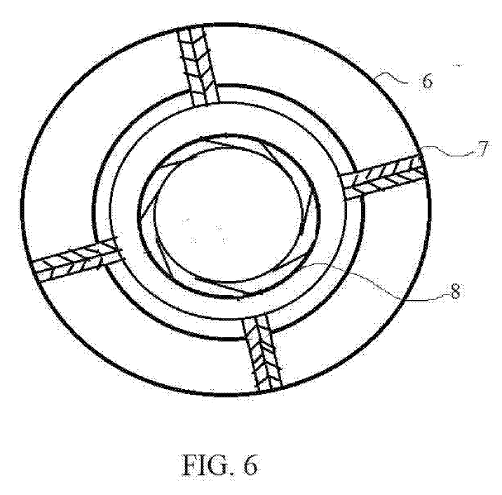

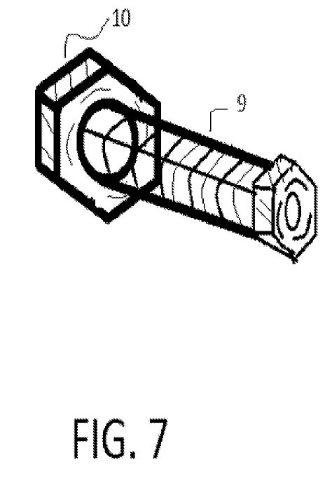

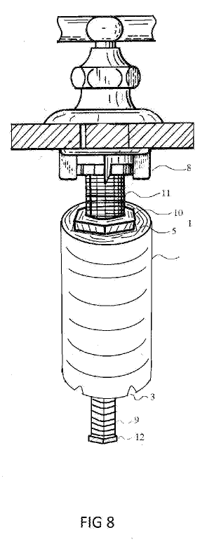

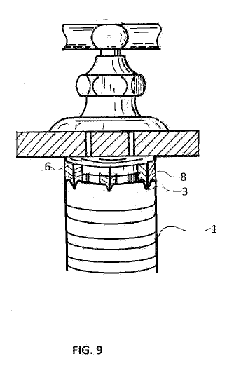

The preferred embodiment of the invention consists of an inexpensive two inch PVC pipe FIG. 1, with one end that has a six sided hole FIG. 3, 5 and FIG. 4, 5 that is designed like a socket to receive the larger six sided nut FIG. 7, 10 that attaches the flexible water hose FIG. 10, 9 to the nipple of the faucet. And the other end of the PVC pipe FIG. 1, with the six notches at the end FIG. 1, 3 and FIG. 2, 3. The method for using it is as follows:
1. To remove the faucet you begin by using a wrench to remove the small nut of the flexible water hose FIG. 7, 11 that is attached to the cold water supply valve. When this nut is removed, you insert the end flexible water hose with the small nut into the end of the Sink Faucet Multiple Tool that has the six sided socket hole FIG. 3, 4, and push the tube FIG. 3, along the water hose until it engages the six sided nut FIG. 8, 10 that is attached to the nipple FIG. 8, 11 of the sink faucet. You then turn the PVC pipe FIG. 3 counterclockwise to unscrew the nut. Once the nut is unscrewed, the flexible hose FIG. 7, will be disconnected from the faucet. You then insert the faucet tool so that the end of the tube shown in FIG. 1, 3 and FIG. 2, 3 inserts the nipple of the water faucet FIG. 8, 11 until the notches FIG. 9,3 and FIG. 1, 3 engage the projecting wings FIG. 9, 8 of the faucet nut FIG. 5, FIG. 6, and FIG. 9, 6 that attaches the faucet to the sink. You then turn the PVC pipe counterclockwise until you unscrew the nut. You then repeat this process for the hot water supply side of the faucet.
2. The reverse of the above method is used to install the new faucet. In the installation you first install the nut that fastens the faucet to the sink. Then you install the large nut of the flexible hose to the nipple of the faucet using the Sink Faucet Multiple Tool.

1. A one to two inch diameter PVC tube or pipe with six notches at one end. The notches are about a quarter of an inch deep. Four of the notches are set 90 degrees apart. The additional 2 notches are set 120 degree apart from one of the original four notches. These notches can engage or fit the four or thee projecting wings of a four ridged (winged) or three ridged (winged) faucet nut that is used to fasten the faucet to the sink.

2. At the other end of the PVC pipe or tube is a six sided hole that is designed like a socket to receive the larger six sided nut that engages the flexible water hose

3. Two separate one to two inch diameter PVC tubes or pipes, one with the characteristics described in claim 1, and the other with the characteristics described in claim 2.
